(19) United States
(12) Patent Application Publication
(10) Pub. No.: US 2012/0047007 A1
(43) Pub. Date: Feb. 23, 2012

(54) Method and apparatus for charging fee to customer

(76) Inventors: James H. Halsey, El Dorado, AR (US); Scott M. Juds, Seattle, WA (US)

(21) Appl. No.: 13/136,794

(22) Filed: Aug. 10, 2011

Related U.S. Application Data
(63) Continuation-in-part of application No. 12/073,479, filed on Mar. 6, 2008.
Application No. 12/073,479 is a division of application No. 11/190,938, filed on Jul. 28, 2005, now abandoned.
(60) Provisional application No. 61/401,252, filed on Aug. 10, 2010.
(60) Provisional application No. 61/458,066, filed on Nov. 17, 2010.

(51) Int. Cl. G06Q 20/34; G06Q 30/02

(52) U.S. Cl. 705/14.14; 705/41; 705/14.15

(57) ABSTRACT

A method and an apparatus for charging all or a portion of the credit card discount fee or debit card discount fee (or other type of card, e.g., smart card, discount fee) to the consumer, customer, end user, credit card owner, or debit card owner, thereby reducing or eliminating the cost of the discount fee to the merchant upon a transaction initiated at the merchant location, are disclosed herein. With the cost of the discount fee to the merchant reduced or eliminated, embodiments disclosed herein allow the merchant to choose to optionally provide benefits, incentives, prizes, discounts (e.g., on services or goods), and/or a game of chance where the consumer, customer, end user, credit card owner, or debit card owner is capable of winning prizes, benefits, incentives, and/or discounts for the consumer, customer, end user, credit card owner, or debit card owner with any portion or all of the discount rate amount saved by the merchant.

### CROSS-REFERENCE TO RELATED APPLICATIONS

This application claims benefit of U.S. provisional patent application Ser. No. 61/401,252, filed Aug. 10, 2010 and entitled “Method and Apparatus for Charging Card Discount Fee to End User” and U.S. provisional patent application Ser. No. 61/458,066, filed Nov. 17, 2010 and entitled “Method and Apparatus for Charging Fee to Customer.” Each of the aforementioned provisional patent applications is herein incorporated by reference. This application is also a continuation-in-part of co-pending U.S. patent application Ser. No. 12/073,479, filed Mar. 6, 2008, which is a divisional of U.S. patent application Ser. No. 11/190,938, filed Jul. 28, 2005, both entitled “Vending Machine Having a Game of Chance” and having the inventors Scott Juds and James H. Halsey. Each of the aforementioned related patent applications is herein incorporated by reference.

### BACKGROUND OF THE INVENTION

1. Field of the Invention

Embodiments generally relate to discount rates for credit card and debit card transactions.

2. Description of the Related Art

Credit cards and debit cards have become commonly-used payment methods for goods and/or services. With a credit card transaction, the merchant originates the transaction by accepting a credit card, and the credit card is read at the point of sale (“POS”). A card reader, which is a device capable of reading the encoding on plastic cards, may enable the reading of the credit card at the POS. The merchant typically has a merchant processing agreement with a bank or third party to originate credit card transactions.

The following excerpt from the FDIC Credit Card Activities Manual describes merchant processing of credit card payments and an overview of the transaction process:

XIX. Merchant Processing

Merchant processing is the acceptance, processing, and settlement of payment transactions for merchants. A bank that contracts with (or acquires) merchants is called an acquiring bank, merchant bank, or acquirer. Acquiring banks sign up merchants to accept payment cards for the network and also arrange processing services for merchants. They can contract directly with the merchant or indirectly through agent banks or other third parties.

A bank can be both an issuing bank and an acquiring bank, but banks most often specialize in one function or the other. Merchant processing is a separate and distinct line of business from credit card issuing. It is generally an off-balance sheet activity with the exception of merchant reserves and settlement accounts, both of which are discussed later in this chapter. Merchant processing involves the gathering of sales information from the merchant, obtaining authorization for the transaction, collecting funds from the issuing bank, and reimbursing the merchant. It also involves charge-back processing. The vast majority of merchant transactions are electronically originated (as compared to paper-based) and come from credit card purchases at merchant locations or the point-of-sale (POS). Merchant processing increasingly includes transactions initiated via debit cards, smart cards, and electronic benefits transfer (EBT) products.

Transaction Process Overview

The payment networks are the center of the cardholder transaction process and maintain the flow of information and funds between issuing banks and acquiring banks. In a typical cardholder transaction, the transaction data first moves from the merchant to the acquiring bank (and through its card processor, if applicable), then to the Associations, and finally to the issuing bank (and through its card processor, if applicable). The issuing bank ultimately bills the cardholder for the amount of the sale. Clearing is the term used to refer to the successful transmission of the sales transaction data. At this point, no money has changed hands; rather, only financial liability has shifted. The merchant, however, needs to be paid for the sale. Settlement is the term used to refer to the exchange of the actual funds for the transaction and its associated fees. Funds to cover the transaction and pay the merchant flow in the opposite direction: from the issuing bank to the Associations, to the acquiring bank, and finally to the merchant. The merchant typically receives funds within a few days of the sales transaction.

In a simple form, the clearing and settlement processes for payments can be illustrated with a standard four-corners model (as discussed in the FFIEC IT Examination Handbook, Retail Payment Systems Handbook (March 2004)). In this model, there is a common set of participants for credit card payments: one in each corner (hence, the term four-corners model) and one in the middle of the diagram. The initiator of the payment (the consumer) is located in the upper left-hand corner, the recipient of the card payment (the merchant) is located in the upper right-hand corner, and the relationships of the consumer and the merchant to their banks (the issuing bank and the acquiring bank, respectively) reside in the bottom two corners. The payment networks that route the transactions between the banks, such as Visa, are in the middle of the chart. The information and funds flows for a typical credit card transaction are illustrated in a four-corners model¹³ labeled Exhibit D (FIG. 1 herein) . . . . Information flows are presented as solid lines while funds flows are represented by dashed lines.

Step 1: The consumer pays a merchant with a credit card.

Steps 2 and 3: The merchant then electronically transmits the data through the applicable Association's electronic network to the issuing bank for authorization.

Steps 4, 5, and 6: If approved, the merchant receives authorization to capture the transaction, and the cardholder accepts liability, usually by signing the sales slip.

Steps 7 and 8: The merchant receives payment, net of fees, by submitting the captured credit card transactions to its bank (the acquiring bank) in batches or at the end of the day¹⁴.

Steps 9 and 10: The acquiring bank forwards the sales draft data to the applicable Association, which in turn forwards the data to the issuing bank.

The Association determines each bank's net debit position. The Association's settlement financial institution coordinates issuing and acquiring settlement positions. Members with net debit positions (normally the issuing banks) send funds to the Association's settlement financial institution, which transmits owed funds to the receiving bank (generally the acquiring banks).

The settlement process takes place using a separate payment network such as Step 11: Fedwire.

The issuing bank presents the transaction on the cardholder's next billing Step 12: statement.

Step 13: The cardholder pays the bank, either in full or via monthly payments.

Exhibit D (FIG. 1) is only a simplistic example of the variety of arrangements that can exist. The parties for the transaction could be one of thousands of acquirers or issuers or one of millions of merchants and consumers. Further, there are many other ways the arrangements can be structured. For example, in on-us transactions, the acquiring bank and the issuing bank are the same. Also, the timing of the payment to the merchant (step 8 of Exhibit D or FIG. 1) varies. Some acquiring banks pay select merchants prior to receiving funds from the issuing bank, thereby increasing the acquiring bank's credit and liquidity exposure. However, payment from the acquiring bank to the merchant often occurs shortly after the acquiring bank receives credit from the issuing bank.

The presence of third-party organizations coupled with the acquiring bank's ability to sub-license the entire merchant program, or part thereof, and the issuing bank's ability to sub-license the entire issuing program, or part thereof, to other entities also introduces complexities to the transaction and fund flows. For example, because the cost of technology infrastructure and the level of transaction volume are high for acquiring banks, most small acquiring banks rely on third-party card processors to perform the functions. In addition, issuing banks often use card processors to conduct several of their services. In intra-processor transactions, the same third party processes for both the acquiring bank and the issuing bank. Under the by-laws and operating rules/regulations of the Associations, the issuing banks and acquiring banks are responsible for the actions of their contracted third-parties, respectively.

A merchant submits sales transactions to its acquiring bank by one of two methods. Large merchants often have computer equipment that transmits transactions directly to the acquiring bank or its card processor. Smaller merchants usually submit transactions to a vendor that collects data from several merchants and then transmits transactions to the acquiring banks.

A discount rate is the fee currently paid by merchants to credit card or debit card processors (e.g., the acquiring bank) as a fee associated with accepting one or more general-use credit cards or debit cards such as Visa, MasterCard, American Express, or Discover. This discount fee is usually between one and four percent, depending upon the nature of the transaction. The following excerpt from the FDIC Credit Card Activities Manual describes the discount rate and other fees charged to the merchant for sales transactions and acquiring bank services:

Pricing

One of the key aspects of a successful merchant program is appropriately setting the fees that the merchant will be charged for sales transactions and acquiring bank services. Merchant pricing is extremely competitive, especially for large- and national-scale merchants who generate high transaction volumes. High transaction volumes can lead to economies of scale and possibly increased income. Examiner should look for evidence that banks have adopted a pricing policy that outlines the methods used for pricing, authority levels, and repricing procedures. A pricing policy can facilitate consistency in pricing practices and help optimize profit margins.

Acquiring banks use various methods to price merchants. Smaller merchants are frequently priced with a single discount rate based on merchant volume and average ticket size. Acquiring banks frequently use unbundled pricing for medium to large merchants. Unbundled pricing is the method of assigning fees for the cost of each service used. Examples of unbundled services include interchange, authorizations, and charge-backs. Other fees may include, but are not limited to: statement preparation, application, customer service, membership, maintenance, and penalty fees (for example, for violating payment network rules).

Examiners should evaluate the bank's practices for ensuring that pricing is consistent with the risk posed by the merchant. Acquiring banks sometimes use a pricing model to determine the target discount rate. They might maintain one or more pricing models, with model usage driven by the merchant's sales volume and/or industry classification. Pricing models allow the acquiring bank to quickly substitute variables regarding sales volumes, average ticket size, revenues and expenses to produce a projected profit margin. A failure of the pricing model to include all direct and indirect expenses may render the model's results meaningless. A model's accuracy depends upon the reasonableness of the assumptions used.

Pricing Components

Discount Rate:

Acquiring banks assign a discount rate for each merchant when the merchant agreement is signed. The discount rate is the percentage that gets “discounted” off the transaction amount that is paid to the merchant, hence the term discount rate. In a simple case, the discount represents a single rate charged to a merchant based on the merchant's sales volume. For example, a merchant with a 2 percent discount rate receives $98 for a $100 credit card sale. Most merchant agreements allow the acquiring bank to change the discount rate for various cost increases. Numerous factors influence the discount rate charged, including, but not limited to, the transaction method, processing volume, and type of merchant business. For example, merchants who use electronic data capture (EDC) are typically charged lower discount rates than paper-based merchants. Discount rates generally range from 1 to 4 percent for small to medium-size merchants and sometimes well below that range for large-volume merchants.

When considering the range of discount rates used by the bank, examiners should call on management to readily explain outliers, including those that are well below the normal range. Banks sometimes give merchants a favorable discount rate because of existing commercial loan or deposit relationships. In other cases, the discount rate is favorable due to a credit card equipment lease arrangement. Packaging may be an acceptable practice, but does not eliminate the need to measure the overall profitability of a merchant relationship. Further, examiner attention should be drawn to situations in which management has offered favorable discount rates to insiders or their related interests.

Interchange Fees:

Interchange fees represent compensation paid by the acquiring bank to the issuing bank. Thus, they are recorded as an expense on the acquiring bank's income statement and as a revenue source on the issuing bank's income statement. Interchange fees are based on several factors such as volume, size, and type of transaction and are usually set by the Associations. They average less than two percent of the purchase price and are typically one of many considerations in determining the size of the discount rate that the acquiring bank charges the merchants. (For on-us transactions, interchange may be reduced, if not entirely eliminated.) A number of merchants and merchant groups have filed lawsuits alleging that the interchange fees set by the Associations for credit card transactions violate anti-trust laws and that the fees paid to accept payment cards are too high. In last quarter of 2006 the Associations began offering pubic access to interchange rate information.

Processing Fees:

Processing fees cover the costs associated with data processing services and vary depending on the size and number of transactions the merchant submits per batch. The processing fee may include data capture and authorization costs. It might go directly to the bank if it handles the processing or to the bank's third-party processor.

ISO/MSP Fees:

The ISO/MSP fee is the amount the acquiring bank pays the ISO/MSP for services provided. It is negotiated and often represents a percentage of the volume that the ISO/MSP-sponsored merchants bring to the bank. The fee agreement between the bank and the ISO/MSP is normally considered when pricing merchants obtained through an ISO/MSP.

Agent Bank Commission:

The agent commission is a fee passed to the agent bank for signing a merchant. This fee could be built into the discount rate or be assessed separately.

Other Income:

Acquiring banks sometimes offer other programs to generate fee income (for instance, equipment leasing). Instances in which management has not researched the legal and compliance aspects of products or services offered or has not priced the programs adequately warrant scrutiny.

The discount rate is an additional cost which the merchant must bear upon each credit card or debit card transaction initiated by the credit card user or debit card user at a merchant location. This discount rate decreases the profit of the merchant upon sale of goods and/or services to the consumer, credit card user, or debit card user.

Therefore, there is a need for a device and method which decreases and/or eliminates the cost to the merchant of the discount rate upon credit card transactions at the merchant location.

### SUMMARY OF THE INVENTION

Embodiments generally may include a method for charging a discount fee of a credit card or debit card to a customer, comprising providing a value carrier to the customer usable at one or more purchasing locations to purchase goods or services of a merchant; adding monetary value to the value carrier using the customer's credit card or debit card; and charging the credit card or debit card discount fee to the customer so that the value carrier has less monetary value than was charged by the customer to the credit card or debit card. Other embodiments may include an apparatus for charging a discount fee of a credit card or debit card to a customer, comprising a credit card or debit card reader for reading information from a credit card or debit card of a customer; a value carrier reader for reading a currency value amount on a value carrier and for adding currency value to the currency value amount; a processor for transferring currency value from the credit card or debit card of the customer to the value carrier and for charging the discount fee to the customer; and a display for displaying the currency value amount on the value carrier and currency value which may be added to the value carrier from the credit card or debit card.

Yet other embodiments may include a method for purchasing goods or services at one or more merchant purchasing locations having a value carrier reader using a value card, comprising providing a value carrier to the customer usable at one or more merchant purchasing locations to purchase goods or services of the merchant; adding monetary value to the value carrier using the customer's credit card, debit card, or other currency, the monetary value added to the value carrier being less than the sales price charged to the customer; and upon the customer's use of the value carrier to purchase goods or services at one or more of the merchant purchasing locations, providing one or more incentives, benefits, prizes, bonuses, or discounts on goods or services or providing or one or more chances to win incentives, benefits, prizes, bonuses, discounts on goods or services to the customer using at least a portion of the difference between the sales price and the monetary value.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a four-corners model illustrating the information and funds flow for a typical credit card transaction.

FIG. 2 is a front view of a carrier loading device.

FIG. 3 is a side plan view of an RFID (radio frequency identification) transceiver usable with the carrier loading device of FIG. 2.

FIG. 4 is an axial cross-sectional view of the RFID transceiver of FIG. 3, illustrating interior components and mount of the RFID transceiver relative to an apertured support.

FIG. 5 is a top plan view illustrating an RFID keyfob assembly in a breakaway holder having the outer dimensions of a standard credit card.

FIG. 6 is a table showing an example of discounts that could be won, a budget for them, and the probability of a customer winning any of them for a Play at the Pump incentive.

FIG. 7 is a table showing an example of discounts that could be won, a budget for them, and the probability of a customer winning any of them for a Play Merchant's Machine incentive.

FIG. 8 shows an exemplary current pump pay station.

FIG. 9 is an embodiment of a gas pump pay station with a game of chance.

FIG. 10 is a table showing an example of discounts that could be won, a budget for them, and the probability of a customer winning them for a game of chance at the gas pump pay station of FIG. 9.

FIG. 11 is a perspective view of a tag and tag reader usable with the gas pump pay station of FIG. 9.

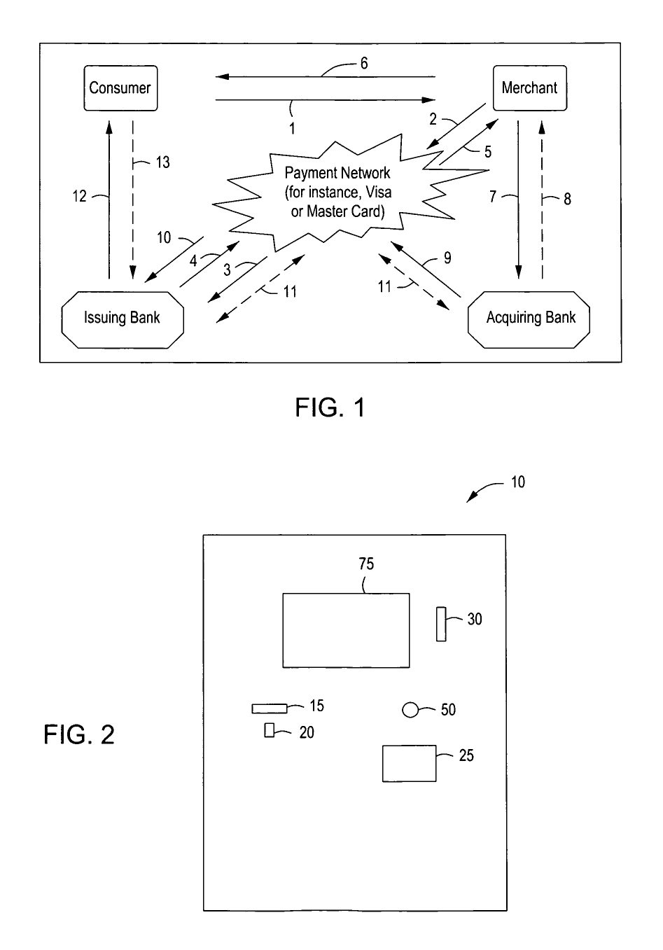

### DETAILED DESCRIPTION

U.S. patent application Ser. No. 12/073,479, filed on Mar. 6, 2008 and entitled “Vending Machine Having a Game of Chance” (U.S. Patent Publication No. 2008/0153567), and U.S. patent application Ser. No. 11/190,938, filed on Jul. 28, 2005 and entitled “Vending Machine Having a Game of Chance” (U.S. Patent Publication No. 2007/0026016), are both herein incorporated by reference in their entireties. Additionally, U.S. patent application Ser. No. 11/404,016, filed on Apr. 14, 2006 and entitled “Methods of Cashless Gaming and Player Tracking” (also publication WO/2007/027753 and International Publication No. PCT/US2006/033831), is herein incorporated by reference in its entirety.

Some embodiments include a device and method for charging all or a portion of the credit card discount fee or debit card discount fee (or other type of card, e.g., smart card, discount fee) to the consumer, customer, end user, credit card owner, or debit card owner, thereby reducing or eliminating the cost of the discount fee to the merchant upon a transaction initiated at the merchant location, e.g., at the POS. With the cost of the discount fee to the merchant reduced or eliminated, the merchant may choose to optionally provide benefits, incentives, prizes, discounts (e.g., on services or goods), and/or a game of chance where the consumer, customer, end user, credit card owner, or debit card owner is capable of winning prizes, benefits, incentives, and/or discounts for the consumer, customer, end user, credit card owner, or debit card owner with any portion or all of the discount rate amount saved by the merchant.

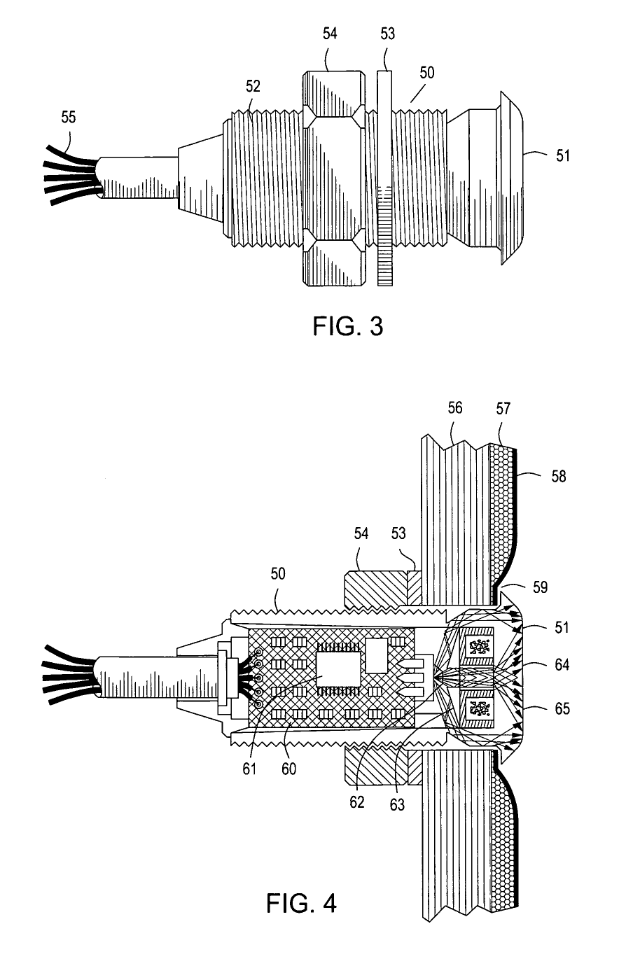

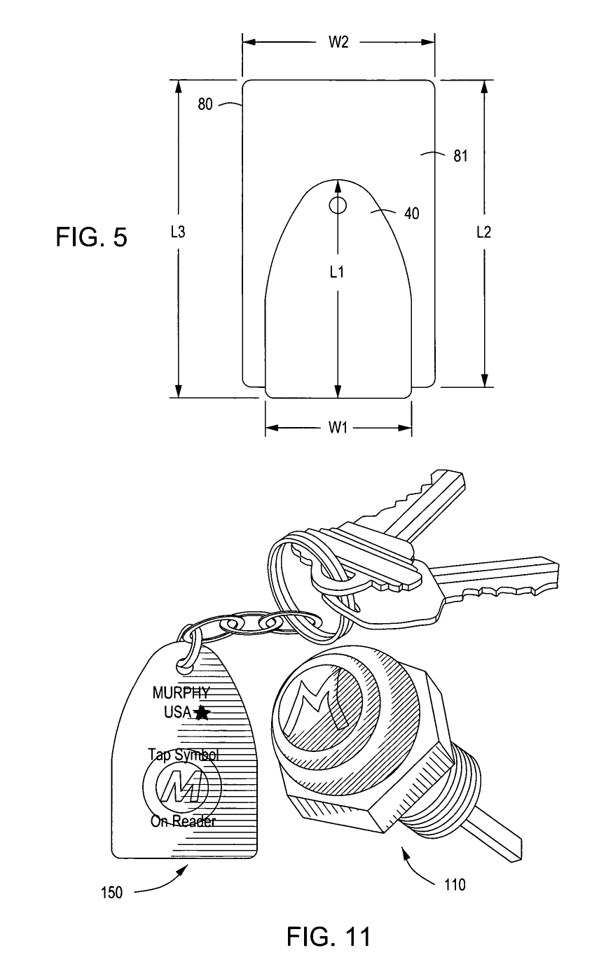

Embodiments may include a value carrier such as an RFID transponder or RFID tag 40 shown in FIG. 5, this value carrier capable of carrying value such as money or currency value thereon. Value such as currency or money value may be added onto the device or removed from the device using a value carrier reader such as an RFID reader or RFID transceiver 50, for example as shown in FIGS. 3-4. A value carrier may include any machine readable card, keyfob, button, or other device which is capable of carrying value such as currency or money value thereon.

FIG. 2 shows an embodiment of a carrier loading and/or dispensing device 10 which is capable of transferring value such as money or other currency onto a value carrier such as the RFID transponder 40. The device 10 may, in one example, be a kiosk. The device 10 may include a value carrier reader 50 which may allow reading of the balance of value which exists on the value carrier as well as loading of value onto the value carrier at the device 10 upon placing the value carrier in proximity with the carrier reader 50. The device 10 may also include a value carrier dispenser 25 from which new value carriers may be dispensed upon a user adding value to the carrier. Although the reader 50 and dispenser 25 are separate as shown in FIG. 2, in other embodiments the reader and dispenser are configured as one unit for performing both the reading and dispensing functions.

Also shown in FIG. 2 are a bill validator 15 for accepting and validating money in the form of bills and a coin acceptor 20 for accepting and validating money in the form of coins. The bill validator 15 and coin acceptor 20 are optional components of the device 10, as it may in some instances be preferred to only allow the adding of value onto the value carrier via credit cards or debit cards (or other types of cards). Although one embodiment of the invention includes the bill validator 15 and coin acceptor 20, these components are representative of any type of currency, including the private currency of sponsored tokens and coupons.

The device 10 may include a point of sale device such as a card reader 30 for reading the encoding on cards such as credit cards and debit cards. Any type of card reader 30 known to those skilled in the art may be employed in the device 10 which allows a card account holder to transfer value from the account holder's card onto the value carrier.

The device 10 may also include a display 75 for displaying information on a screen relating to the value balance disposed on the value carrier and the value to be added to the value carrier. The display 75 may be capable of displaying a touch keypad which allows a user to touch the screen at shown locations to indicate the amount of value to transfer from the card owner's credit card or debit card (or other type of card) onto the value carrier. In other embodiments, a separate keypad (not shown) may be incorporated into the device 10 to allow a user to press or touch one or more keys on the keypad to indicate the amount of value to transfer from the card owner's credit card or debit card (or other type of card) onto the value carrier.

The device 10 may include a processor and other traditional computing components known to those skilled in the art for allowing data supplied by the user or associated with the value carrier to be displayed on the display 75 and transferring the value from the credit card, debit card, other type of card, bill acceptor, and/or coin acceptor to the value carrier.

An embodiment for a value carrier is an RFID transponder or RFID tag, as shown and described in U.S. Pat. No. 7,268,688 filed on Aug. 31, 2005 and entitled “Shielded RFID Transceiver with Illuminated Sensing Surface” and having the inventor Scott Juds, which patent is herein incorporated by reference in its entirety. RFID transponders, such as the cylindrical keyfob 30 of FIG. 3A in U.S. patent application Ser. No. 11/404,016 incorporated by reference above, have a long standing record for quickly and securely linking to a patron's credit card account to effect payment at the gas pump. This service is marketed by Exxon/Mobile under the Speedpass® trademark. The keyfob 30 may be manufactured by Texas Instruments, operate at 134 KHz and have a 64 bit read-only serial number. The keyfob 31 of FIG. 3B (also shown in U.S. patent application Ser. No. 11/404,016), also manufactured by Texas Instruments and marketed under the Tag-It® trademark, operates at 13.56 MHz, has a flat internal inlay 32 of FIG. 3C, a printed antenna 33, a transponder chip 34, and a 64 bit read-only serial number. The 64 bit serial number provides over 18 billion-billion different numbers, enough for three billion per person on earth, and which is enough to ensure there will never be two alike, at least not in the lifetime of anyone alive today. These RFID transponders additionally have a programmable user data area that can be used to identify the sponsor and various application specific parameters. One of the primary reasons for embracing RFID technology is the degree of difficulty of counterfeiting it. Even American Express and MasterCard have embraced and have started to market credit cards with an embedded Texas Instruments Tag-It® RFID inlay. In addition to the aforementioned security value of RFID, other relatively important qualities of the technology include its low cost and its physical reliability.

The denomination value could be stored as additional information along with the ID (identification) code on the value carrier. Such a value carrier may take the form of an RFID keyfob 40 of FIG. 5 having a product trade name and/or merchant trade name printed on a front face.

Optionally, the value carrier may include customer identification information stored thereon including name, address, phone number, etc. The customer may optionally input the information at the device 10 when purchasing a new value carrier.

The denomination amount associated with the value carrier may be stored in the merchant account database, or may be written into an additional user data area of the RFID transponder memory when it is configured for the application. In one embodiment of the invention, the denomination information is stored on the RFID transponder.

An RFID transceiver 50 suitable for use as a value carrier reader for RFID keyfob 40 of FIG. 5 is illustrated in FIGS. 3 and 4, and is the subject matter of co-pending U.S. patent application Ser. No. 11/214,922 filed on Aug. 31, 2005 in the name of Scott Juds, now U.S. Pat. No. 7,268,688, which patent is incorporated herein by reference. The RFID transceiver 50 has a sensing face 51, a threaded tubular body 52 for through-panel mounting, a washer 53 and a nut 54 for securing the mounting, and wires 55 for providing power and communication with other system components. FIG. 2 illustrates the mounting of the RFID transceiver 50 through a carrier loading and/or dispensing device 10. Tightening the nut 54 against washer 53 on the device 10 may mount the RFID transceiver 50 to the device. The RFID transceiver 50 has a circuit board 60 having component parts 61 and others for creating the RF signals necessary for interrogation of the keyfob transponder and for interpretation of the corresponding signals received. The RF signals are transmitted and received through a ferrite core antenna 64. The sensing face 51 of RFID transceiver 50 is illuminated by a multi-color light emitting diode (LED) 62 which emits light into a light pipe 63 for transmission through and around a ferrite pot core 64. The LED 62 is preferably a red, green and blue (RGB) type capable of producing any color desired through proper combination of the three base colors red, blue and green, and the relative intensity control of each. Thus, the RFID transceiver 50 can optionally directly indicate to a user the status of a transaction by the color of its illumination similar to that which is detailed by information 44 on the back face of the RFID keyfob 40 of FIG. 4B of U.S. patent application Ser. No. 11/404,016. Each icon adjacent to one of the transaction states of the information 44 may be printed with its respective color. For example, IDLE (FIG. 4B of U.S. patent application Ser. No. 11/404,016) may be blue, ACCEPT may be green, REJECT may be red, UNABLE may be yellow, TRACKING may be white, and NO SERVICE may be purple. The RFID transceiver 50 is designed to communicate via RS-232.

The die cutting layout shown in FIG. 5 has a value carrier 40 embedded in a retainer portion 81 providing a card assembly 80 which may have the overall dimensions of a standard credit card. The retainer portion 81 is easily broken away from the value carrier 40 by the patron after dispensing. There are numerous credit card dispensers available on the market, such as the CDT-200 Series from Vendapin L.L.C., that could be adapted to dispense the card assembly 80. The retainer portion 81 can further serve to carry printed introductory instructions to aid a customer's understanding of what to do with the value carrier 40. The CDT-200 Series dispenser includes the capability to both hold or to fully eject the card assembly 80.

In one embodiment, the discount fee charged upon use of the credit card or debit card or other type of card in the device 10 may be paid by the credit card owner or debit card owner (or other type of card owner) or end user of the credit card or debit card (or any other type of card) at the device 10 (rather than by the merchant).

In operation, an end user may either purchase a new value carrier using the device 10 or add value to the user's existing value carrier using the device 10. When purchasing a new value carrier, the credit card owner or end user may add value to the value carrier by one or both of the following: (1) inserting one or more bills and/or coins into the bill validator 15 and/or coin acceptor 20 and/or (2) allowing the credit card owner's credit card and/or debit card (and/or other type of card) to be read by the card reader 30, either by inserting the credit or debit card into a slot associated with the card reader 30 or placing the credit or debit card in the required proximity to the card reader 30 (e.g., when the card reader 30 is the type that does not require contact of the card with the reader). If the user adds value to the value carrier using one or more bills and/or coins, the value of the accepted bills and/or coins are placed in escrow, and from escrow the value is then placed on a value carrier. The value carrier is then dispensed from the dispenser 25 to the end user/consumer/customer. The end user may then add more value on the value carrier via debit card, credit card, other type of card or credit/debit device, one or more bills, and/or one or more coins as described below in this patent application (via placing the value carrier in the proximity of the carrier reader 30 and adding value to the value carrier as described below).

When one or more credit cards and/or debit cards (and/or other types of cards) are used to add value to the value carrier, the consumer/customer/end user either inserts the credit card and/or debit card (or other type of card) into the card reader 30 or places the credit card or debit card (or other type of card) in the required proximity to the card reader 30, depending on which type of card reader is utilized and its requirements for reading cards. In some embodiments, the credit card and/or debit card numbers and other validating information may be entered into the keypad (via either touch screen on the display 75 or a separate keypad on the device 10) in lieu of using the card reader 30. Once the card reader 30 approves the transaction, the user may be prompted by the display 75 screen to enter an amount of value to transfer into escrow from the credit card or debit card (or other type of card). In some embodiments, the user is permitted to select from set, predetermined amounts displayed on the screen, while in other embodiments, the user is permitted to enter an amount using the keypad. Both of these options may also be provided to the user.

Once the user selects an amount of value to charge the credit or debit card or other type of card, that value is placed in escrow on the device 10. The discount rate typically charged to the merchant for use of the credit and/or debit card is charged to the credit card owner or debit card owner (or other card owner) upon validation of this transaction. The screen of the display 75 may optionally notify the user that the discount fee is being charged to the credit card owner prior to or subsequent to the transaction which transfers value from the credit or debit card (or other type of card) into escrow. The value which is transferred into escrow is then transferred from escrow onto a value carrier using the device 10, and the value carrier is dispensed to the user from the dispenser 25. The end user/consumer/customer may then add more value on the value carrier via debit card, credit card, other type of card, one or more bills, and/or one or more coins as described below in this patent application (via placing the value carrier in the proximity of the carrier reader 30 and adding value to the value carrier as described below).

To add value to the user's (or consumer's or customer's or card owner's) existing value carrier using the device 10, the user either inserts one or more bills and/or coins into the bill validator 15 and/or coin acceptor 20 to place that value into escrow or inserts the credit card owner's credit card or debit card or other type of card into the card reader 30 (or places the credit card or debit card or other type of card in the required proximity to the card reader 30) and enters the amount of value to place into escrow from the credit card or debit card or other type of card, as described above. If using the credit card or debit card or other type of card, any discount fee may be charged to the credit card owner rather than the merchant (and as described above, the user/customer/consumer may be notified of this fact by the device 10). The user/customer/consumer then places the existing value carrier in the required proximity of the carrier reader 50 so that the value is transferred from escrow onto the value carrier. (Of course, the user/customer/consumer may place the existing value carrier in the required proximity of the carrier reader 50 at any point during this transaction, including prior to adding value to the value carrier.)

When adding value to an existing value carrier, the value carrier may be placed in the required proximity to the carrier reader 50 to permit reading of the value carrier by the carrier reader 50 and loading of value onto the value carrier prior to, during, and/or after the credit card or debit card (or other card) transaction transferring value from the credit card or debit card (or other card) to escrow. The carrier reader 50 may also optionally be used to check the balance of the value carrier for the user, with or without the user adding value to the value carrier, by placing the value carrier within the required proximity of the carrier reader 50 and viewing the balance on the display 20.

The end user may then use the value carrier to purchase goods and/or services at a purchasing location. The purchasing location would include a carrier reader similar to the carrier reader 50 of the device 10, where the carrier reader at the purchasing location would be capable of reading the value on the value carrier upon placement of the value carrier in the required proximity to the carrier reader. The value on the value carrier may be displayed on a display at the purchasing location, and the amount of value required to pay for the goods and/or services may be debited from the value carrier at the purchasing location.

Although the carrier dispensing device 10 and the purchasing location may be separate locations in some embodiments, in other embodiments the device 10 and purchasing location may be the same (using the same device to dispense and add value to the value carrier as well as purchase the goods and/or services and debit value from the value carrier). When the device 10 and purchasing location are the same, only one carrier reader 50 may optionally be utilized for adding value and decreasing value from the value carrier, and only one display 20 may be utilized for showing current value, added value, or decreased value of the value carrier to the end user. In some exemplary embodiments, the value carrier dispensing and value adding device and purchasing location may be at a gas pump. In other embodiments, the value carrier dispensing and value adding device and purchasing location may be in a convenience store, grocery store, or other building.

The merchant may use the saved discount fee for any purpose, including keeping the fee, charging the consumer less for the product or services due to the merchant's saving that discount fee, and/or providing prizes, promotions, incentives, and/or other marketing tools (e.g., the tenth item is free, $5 discount on the item, etc.) to the consumer with that additional discount fee that the merchant is saving.

Some exemplary marketing tools which a merchant, such as a merchant which sells gasoline, may use are described below. In these embodiments, the purchasing location may be at a gasoline pump. The following describes exemplary marketing tools which allow the merchant providing gasoline to provide incentives for the consumer/customer/end user to use the value carrier to purchase gasoline (thereby transferring the responsibility for paying the discount fee from the merchant to the credit card owner, debit card owner, or other card owner) at the gasoline pump.

Merchants could save money and increase profits by making the credit card charges go away. In an example of a $60 credit card purchase with 1.6% discount fee plus $.20 transaction fee the cost to the merchant for these fees amounts to $1.16, whereas a debit card may typically be only $0.35 total cost for these fees to merchant. As will be further described later, it really should not be as important to the merchant that it have their name on the debit card (merchant-branded debit card), but that it just is a debit card being used by the consumer/customer/user/card owner. Since a debit card can be detected based on the card number prefix, then theoretically the merchant could implement an “instant account” strategy with regard to game related discounts. Full registration could further bestow the customer with a birthday discount, online account access to view their discount wins, online coupons for collateral goods sold, etc.

There are many differences embodiments disclosed herein could make happen by providing incentives for paying with the value carrier versus other methods/means of payment. In order for a merchant to be different from its competitors, it must uniquely control the difference. It cannot be something provided by a supplier that is also made freely available to their competitors. It also cannot be something that has no barrier to entry for an interested competitor. Below are four possible exemplary ways to “Win With a Merchant”:
1) Win Lotto Gas, e.g., up to 50 gallons of gas per month for 12 months, when paying with a value carrier;
2) Play at the Pump to win future gas discounts (or other types of product/services discounts with the merchant) when paying with a value carrier;
3) Play Merchant's Machine to win future gas discounts (or other types of discounts when paying with a value carrier; and/or
4) Get Birthday Bonus Gas (or other bonus services or products from the merchant) on your birthday when using your registered value carrier.

Win Lotto Gas, Play at the Pump, and Play Merchant's Machine may be generally about providing a random discount to customers on a future purchase of the same thing. These incentives may instead provide a random discount to customers on a future purchase of a different item or service offered by the merchant. The gumball aspect of the merchant's machine does not require a customer purchase, just registration and showing up. The Birthday Bonus is a discount for registered customers on their birthday.

Win Lotto Gas

The Win Lotto Gas incentive may, for example, allow the owner of the value carrier the chance to win up to 50 gallons per month for 12 months when paying with a value carrier.

A lottery is characterized by a big prize and awarded based on numbers selected by the contestants. Unlike the other ways to “Win with a Merchant,” this one is intended to optionally additionally drive customers to a merchant web site. Why? Getting additional mind share of the customer is one answer. Getting advertising revenue by the same model perfected by Google and Yahoo is a second answer. Getting storefront sales referral revenue through execution partners such as Amazon is a third answer. Driving customers to go back to the gas station with e-coupons collected online for items such as milk and beer is a fourth answer.

Following is an explanation of operating costs of the Win Lotto Gas incentive. The cost of having a winner in the example is approximately $3.50×50×12=$2,100. If one considered all Web-related revenue as an offset to implementation and operation overhead costs, then one might ask: how many debit card (value carrier) customers per day it would take to fund a daily drawing? If 0.2% of revenue, for example, was budgeted and the average tank fill is 14 gallons (gal.), it would take (600 gal.)/(15 gal.)/(0.2%)=20,000 customers. If 40% of nearly 500 customers per day per site participated, the merchant could have about 24 winners per day over its 975-site network.

The following may be components of the Win Lotto Gas incentive:

(1) a merchant server for holding customer account information, serving up Web pages with customer relevant content, and communicating information with pump controllers;

(2) an interne connection between the server and the gas pump capable of exchanging some or all of the following information: a) card number of a customer at a pump, b) price/discount/limit information associated with that card number, c) the gallons pumped and the amount charged to the card, d) customer greeting information for display at the pump, e) other customer messages related to account status, f) e-coupon reminders;

(3) a pump controller that can receive and use complex pricing information from the server, such as: Standard Price=$3.67, Discount=25% on next 12 gallons, Discount=5% thereafter, Gallon Limit=23.4;

(4) a pump controller capable of displaying the aforementioned information, in some embodiments receiving it in HTML and XML format so as not to be restrained by a fixed data field protocol;

(5) a merchant marketing group and a merchant Webmaster to keep the advertising fresh.

Operation of the Win Lotto Gas incentive may be accomplished by the following steps:

(1) The customer goes to the gas station and uses his or her value carrier to buy gas at the pump. When done with the gas purchase, the value carrier purchase information may be reported to the merchant server containing merchant customer accounts. In an example, one Lotto Chance Credit per $10 spent on a purchase would then be allocated to the customer.

(2) The customer goes to the Win Lotto Gas Web site and logs in to his or her account to play. In this example, each day he or she can use only one Lotto Chance Credit. To play he or she may be required to enter his/her favorite number, or to select one of his/her favorite past numbers, and to click the ENTER button. The screen may confirm that he/she is officially entered.

(3) While at the Web site, the customer may also do one or more of the following: a) click on a related topic ad provided automatically by Google or another internet ad provider, for which a click may be worth for example $.05, or b) click on an ad which puts an e-coupon, good for 24 hours for example, into the customer's account for a special price on drinks/snacks/etc. and where the customer is then driven back to a merchant station to get them, or c) click on an ad to buy something like floor mats or a car stereo through an intermediary like Amazon, who handles the entire order and shipment of goods, with a sales commission automatically going to merchant.

(4) The contest may run on the merchant server at a certain time each day, for example at midnight. Random numbers may be drawn until there is a winner. If there are two numbers that are the same you could either give it to the first one who registered the number, divide the winnings between them equally, or divide the winnings between them weighted more heavily toward the person selecting the number earlier. You could also warn a customer that a particular number has already been selected by someone else and that it is just not available for next Lotto drawing. The winner will have the gas credits posted to his account. The status of how many months or gallons are left may be viewed on the Web site.

(5) When the customer goes to a merchant station, he or sue uses his or her value carrier at the pump, the pump controller gets pricing information for this customer for visual display and for determining the price to charge the customer, if any.

(6) The merchant may use the list of recent winners in its advertisements.

Although the above example involves “Win Lotto Gas” as described above, goods and services other than gas may be paid for by the value carrier to permit the owner of the value carrier to receive incentives in the manner described above in relation to gas. Additionally, although the above example involves prizes/incentives being awarded to the value carrier owner which involve gas, any other product or services may be the prizes in the manner described above in relation to gas. Also, the “Win Lotto Gas” incentive may be tied and awarded at any location and is not limited to purchase of the goods/services at a gas pump.

Play at the Pump

The Play at the Pump incentive may, for example, allow the owner of the value carrier to win future gas discounts when paying with a value carrier.

The concept of Play at the Pump is one in which a game of chance is actually played on the LCD screen of the pump controller. Ideally this happens within a Web page window so that it can be independently controlled and managed by the merchant, rather than by the pump controller manufacturer, such as Gilbarco, in order to avoid POS and UL re-certification delays and costs when changes to the game are desired. It is intended to increase customer loyalty and thus monthly revenue per customer, and to generate a viral marketing response in customers who may excitedly tell all of their friends about what they have won.

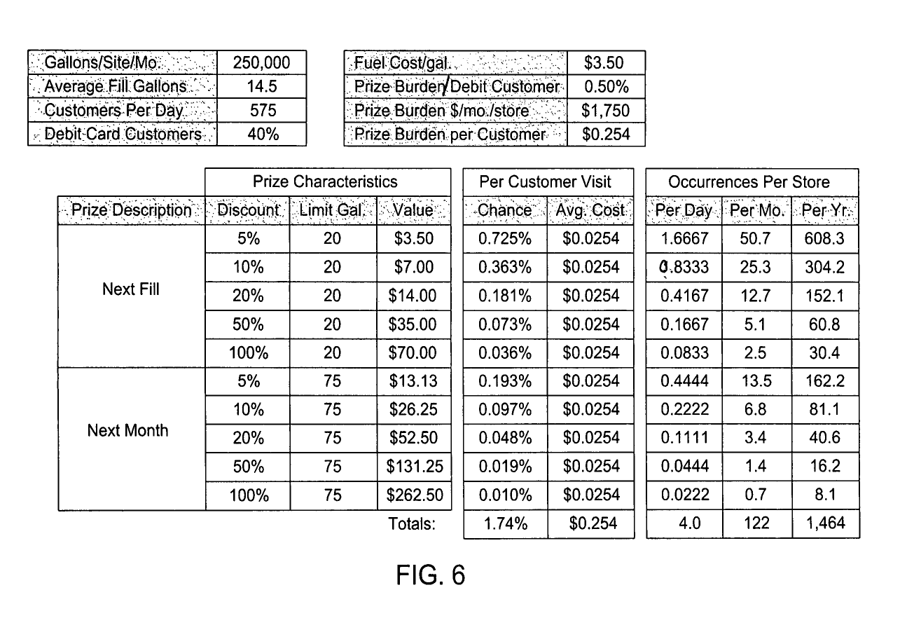

FIG. 6 is a table showing an example of discounts that could be won, a budget for them, and the probability of a customer winning any of them. This table shows example discounts and operating costs. The probabilities should be in proportion to the amount of fuel actually purchased in order to prevent customers from doing multiple small gas tank fills or multiple small purchases (when not used in relation to gas, but with other products/services) in order to play more games. Note that there are an estimated 4 new customers per day that are going to do viral marketing in the community after winning.

The following may be components of the Play at the Pump incentive:

(1) a merchant server for holding customer account information, serving up Web pages with customer relevant content, and communicating information with pump controllers;

(2) a pump controller with the ability to display Web pages with custom information based on transmitting the payment card number to the server and receiving back pricing and display information;

(3) an Internet connection between the server and the pump capable of exchanging some or all of the following information: a) card number of a customer at a pump, b) price/discount/limit information associated with that card number, c) the gallons pumped and the amount charged to the card, d) customer greeting information for display at the pump, e) other customer messages related to account status, f) game interaction information;

(4) a pump controller that can receive and use complex pricing information from the server, such as: Standard Price=$3.67, Discount=25% on next 12 gallons, Discount=5% thereafter, Gallon Limit=23.4;

(5) a pump controller capable of displaying the aforementioned information, in some embodiments receiving it in HTML and XML format so as not to be restrained by a fixed data field protocol.

Operation of the Play at the Pump incentive may be accomplished by the following steps:

(1) The customer goes to the gas station and uses his or her value carrier to buy gas at the pump. The value carrier number is reported to the merchant server containing merchant customer accounts.

(2) The server responds with price/discount/limit information for the pump controller, and optionally a web page greeting the customer.

(3) When the customer is finished pumping gas, the total gallons and total charge is reported to the server. It responds, for example by thanking the customer and offering him or her a chance to play Spin the Nozzle to win future discounts.

(4) If the customer accepts, he or she hits a button and the nozzles spin. The probability of win is proportional to the amount spent since the last game was played and according to FIG. 6.

(5) If the customer wins, the terms of the prize may be specified on the screen and stored on the server.

Play Merchant's Machine

The Play Merchant's Machine incentive may, for example, allow the owner of the value carrier to win future gas discounts when paying with a value carrier.

The Merchant Machine is really a close incarnation of what we have called the “grocery store slot machine”, with the following differences in some exemplary embodiments: a) only gumballs may be dispensed—all other prizes may be gas purchase future discounts stored on the merchant server, b) no purchase is needed to get your gumball—limit one per day per registered value carrier, c) gas discount prizes have a win probability in proportion to the amount of gas purchased with your value carrier since the last game played, d) if a discount prize is not won, the customer always will get at least a gumball. Perhaps the machine should be called the Merchant Magic Machine because it creates future gasoline for you out of nothing at all.

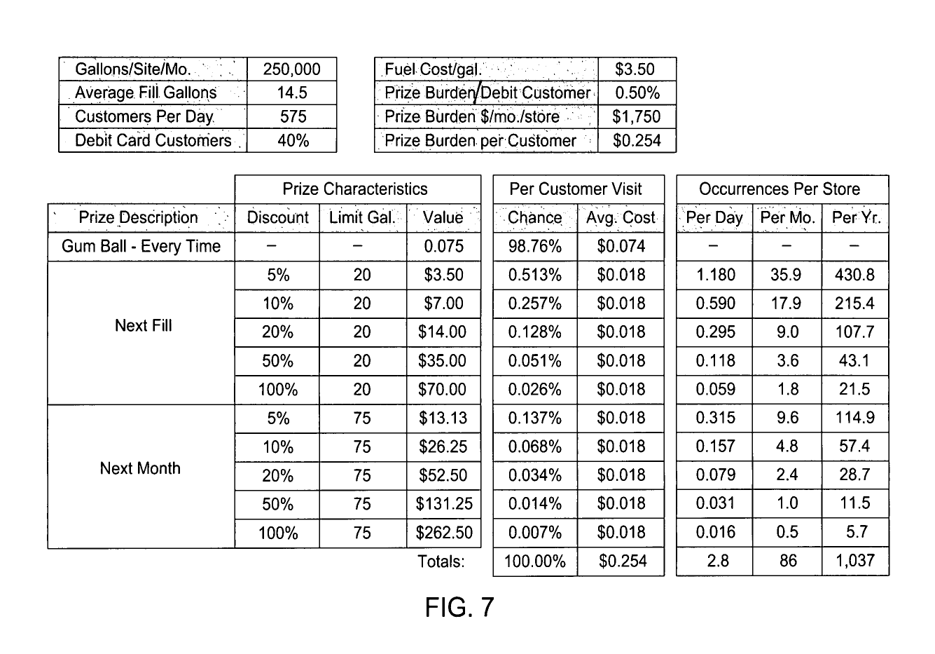

FIG. 7 is a table showing an example of discounts that could be won, a budget for them, and the probability of a customer winning any of them. In some embodiments, the game may be played a maximum of once per day. In some embodiments, the very least a customer will win from playing the machine is one gumball, just for showing up. The probabilities of winning gas discounts should be in proportion to the amount of fuel purchased in order to prevent customers from making multiple small purchases, e.g., doing multiple small gas tank fills, in order to play more games. Note that there may be approximately 2.8 new winning customers per day which may do viral marketing in the community, not to mention all the kids wanting their parents to go to the merchant to get the free gumball.

The following may be components of the Play Merchant's Machine incentive:

(1) a merchant server for holding customer account information, serving up Web pages with customer relevant content, and communicating information with Merchant's Magic Machine;

(2) an Internet connection between the server and the pump capable of exchanging some or all of the following information: a) card number of a customer at a pump, b) price/discount/limit information associated with that card number, c) the gallons pumped and the amount charged to the card, d) customer greeting information for display at the pump, e) other customer messages related to account status;

(3) a pump controller capable of receiving and using complex pricing information from the server, such as: Standard Price=$3.67, Discount=25% on next 12 gallons, Discount=5% thereafter, Gallon Limit=23.4;

(4) a custom kiosk (Merchant Magic Machine) having an LCD color touch screen, Internet connection and browser, software to communicate with the merchant server, card reader, and optionally a gumball dispenser.

Operation of the Play Merchant's Machine incentive may be accomplished by the following steps:

(1) The customer goes to the gas station and uses his value carrier to buy gas at the pump. The value carrier number is reported to the merchant server containing merchant customer accounts.

(2) The server responds with price/discount/limit information for the pump controller.

(3) When the customer is finished pumping, the total gallons and total charge are reported to the server.

(4) The customer goes into the mini-mart and plays the Merchant Magic Machine and either wins a gumball or a future discount on purchase of merchant gas (or other merchant goods or services). Won discounts are stored on the server.

Get Birthday Bonus Gas

The Get Birthday Bonus Gas incentive may, for example, allow the owner of the value carrier to win bonus gas or other goods or services on his or her birthday when using or paying with his or her registered value carrier.

Birthday bonus gas could include, for example, giving the customer one free gallon of gas for every 20 purchased on his or her birthday, possibly implemented as a 5% discount, and possibly with a limit of the first 60 gallons pumped that day. This feature could operate with or without any of the other promotional systems previously described.

Alternatively, some sort of extra e-coupons could be made available to the customer on the merchant Web site for the customer on his or her birthday, or the customer could be given a free Spin The Nozzle game on his or her birthday as if he/she had purchased some gas, or an extra spin on his/her birthday if he/she does purchase gas and with the same odds given for the first normal spin to thus effectively double his/her chances.

With respect to operating costs, if a person fills his or her tank once a week on average, then the cost to give the Birthday Bonus Gas would be the same as giving a 5% discount once every 52 times or effectively giving an average of about 0.1% discount. This system may operate piggy-back on any of the other discount systems with no further hardware.

In U.S. patent application Ser. No. 12/073,479 and U.S. patent application Ser. No. 11/190,938 incorporated by reference above, both entitled “Vending Machine Having a Game of Chance,” four separate kinds of vending machines are disclosed:

(1) The “grocery store slot machine” is always dispensing at least a low value item (gumball) unless a higher value item is won and then either dispensing the higher value item or a coupon for the item.

(2) The “coke machine” version uses a token to provide a random fractional vend value of an item, and might include some sort of grand prize thing as well.

(3) The “product sample” version for using a token to get a free product sample and possibly win a grand prize.

(4) The “Lucky Time” version for instantly winning a random amount of time in a car wash.

The Win Lotto Gas concept does not involve a game of chance at a vending machine (the gas dispenser or even a gumball dispenser), but it involves an online lotto funded by a portion of the price used to pay for pumped fuel with prizes delivered via future price discounts automatically received at the pump.

The Merchant Magic Machine system is more than just a vending machine having a game of chance and more than a smart pump/dispenser. It is more of a system for discounting fuel pricing based on the outcome of a game of chance played on a separate kiosk with a purpose of drawing folks into a mini-mart. Features of embodiments disclosed herein include one or more of the following:

(1) Registered value carrier user with fuel purchase history is allowed to play a game of chance at a kiosk.

(2) In some embodiments, if nothing else has been won in the game of chance, a gumball (or other goods or services) is always dispensed.

(3) Storing an e-coupon on the server is the result if any prize is won in the game of chance.

(4) Automatically using customer e-coupon at a fuel pump when paid for by the registered debit card/value carrier.

(5) Fuel pump may be capable of dispensing gas at a first price for x gallons and second price thereafter, per e-coupon, for a customer with a value carrier.

(6) Fuel pump may be capable of displaying price breakdown, including discounts and amounts applied.

(7) Note: Kiosk may also allow registration of an unregistered value carrier that has been used at the pump.

(8) Note: The Kiosk is not just like having another vending machine on a network. Pumps are different.

The Play at the Pump is not really much different from the Merchant Magic Machine in some embodiments except that it is located in the pump rather than the mini-mart, and there is no gumball dispensed. The customer could elect to play before fueling if the customer did not play after last fueling, in which case anything won will be applied to the fueling he or she is about to do. If the customer elects to play after fueling, then anything won could be available for credit during his/her next fueling. In some senses this is similar to Lucky Time in that anything won at the pump is just more of what you are already buying at the pump.

Play at the Pump may be a fuel vending machine having a game of chance to win future discounts saved on a server as e-coupons for application to subsequent purchases. Embodiments disclosed herein include one or more of the following:

(1) Registered value carrier user with fuel purchase history is allowed to play a game of chance at pump.

(2) Storing an e-coupon on the server may be the result if any prize is won in the game of chance.

(3) Automatically using customer e-coupon at a fuel pump when the gas/goods/services are paid for by the registered value carrier.

(4) Fuel pump may be capable of dispensing gas at a first price for x gallons and second price thereafter, per e-coupon.

(5) Fuel pump may be capable of displaying the price breakdown, including discounts and amounts applied.

(6) Doing it in a browser window at the pump to make it immune to controller change certification issues.

For all of the games of chance described herein, the game does not have to involve gasoline awarded as prizes, discounts, bonuses, incentives, etc. but instead may involve any other goods and/or services sold by the merchant, and the purchased product with the value carrier does not have to be gas but may instead be any other goods and/or services sold by the merchant. Additionally, the bonus, incentive, discount, prize, benefit, etc. does not have to be awarded at a gasoline pump pay station, and the game does not have to be played at the gasoline pump pay station; rather, any merchant location for awarding and playing is within the scope of embodiments. In some embodiments, the merchant location may be a grocery store or department store, and the payment location for paying for the goods and/or services of the merchant with the value carrier may be a checkout pay station in the store.

In one embodiment, the incentives, benefits, prizes, bonuses, and/or goods and/or services obtainable by the customer/user/consumer upon use of the value carrier to pay for goods and/or services of the merchant may include a lottery ticket and/or playing of a lottery game (or a chance to win a lottery ticket and/or play of a lottery game) sanctioned by a state lottery commission such as the Arkansas Scholarship Lottery or third party lottery vender. Some example lottery games which may be played or tickets awarded to the customer/user upon payment using the value carrier for goods and/or services at the vender (the goods may for example be gasoline at a gas pump) include Cash4, MegaMillions, Decades of Dollars, Powerball, Fire N Dice, and Hot Cash Fast Play. All or a portion of the discount fee saved by the merchant due to the customer's use of the value carrier in lieu of credit card, debit card, or other type of card (and if the customer/credit card or other card owner paid for it by credit or debit or other type of card, the discount fee paid for by the card owner instead of the merchant) may be used to pay for the lottery tickets or games. In some embodiments, a lottery ticket may be won or a lottery game may be played upon payment for gasoline by the customer using a value carrier. In some embodiments, the lottery ticket or lottery game may be dispensed or located at the gasoline pump pay station, and in other embodiments the customer may be required to redeem his or her lottery ticket or lottery game play inside the merchant's place of business (thereby drawing the customer into the merchant's place of business to hopefully buy other goods and/or services of the merchant). In other embodiments, the lottery ticket or lottery game play (or the chance to win a lottery ticket or lottery game play) may be awarded at the merchant's checkout pay station (e.g., in a grocery store) upon payment for goods and/or services of the merchant using the value carrier.

FIG. 9 shows an exemplary embodiment of a gas pump with a game of chance using a value carrier and value carrier reader 110 at the gas pump (wickets at the pump), with Murphy USA as the exemplary merchant. The game of chance at the gas pump would draw in repeat customers by marketing to the public that “the day you filled up elsewhere was likely your lucky day here!” The display 120 of the gas pump could be used to show the discount or other incentive that the customer won by using his or her value carrier at the value carrier reader 110.

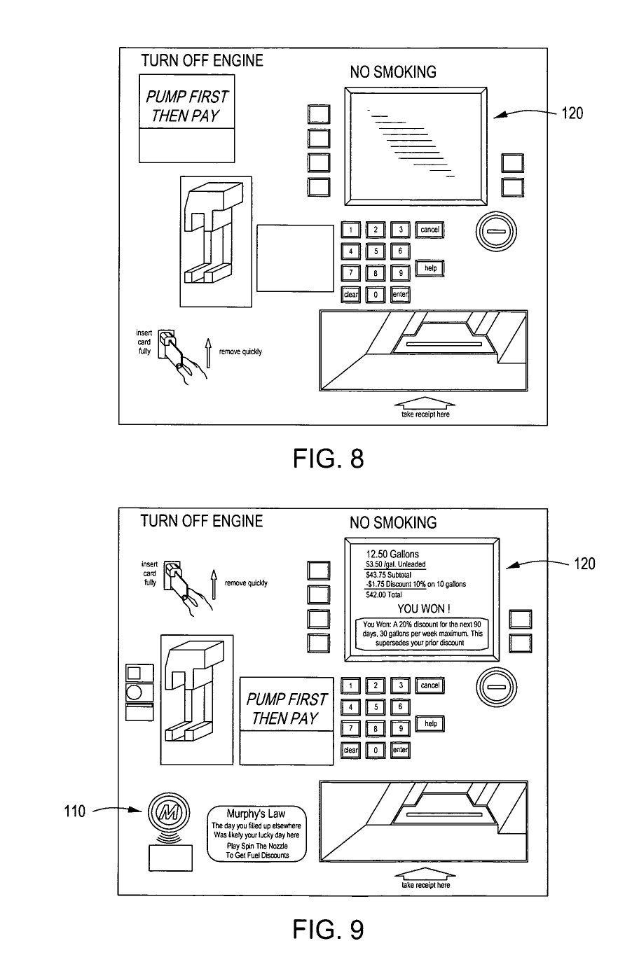

FIG. 8 shows a typical pump pay station to contrast it with the gas pump with the gas pump with the game of chance shown in FIG. 9.

The gas pump with a game of chance would allow a merchant to be different than other merchants and draw customers in with the incentives, prizes, discounts, etc. A chance to win by using the value carrier will bring customers in to a merchant and will encourage them to use the value carrier versus other forms of payment. The chance to win would also encourage a customer to pay the discount rate on a credit card loading of the value carrier.

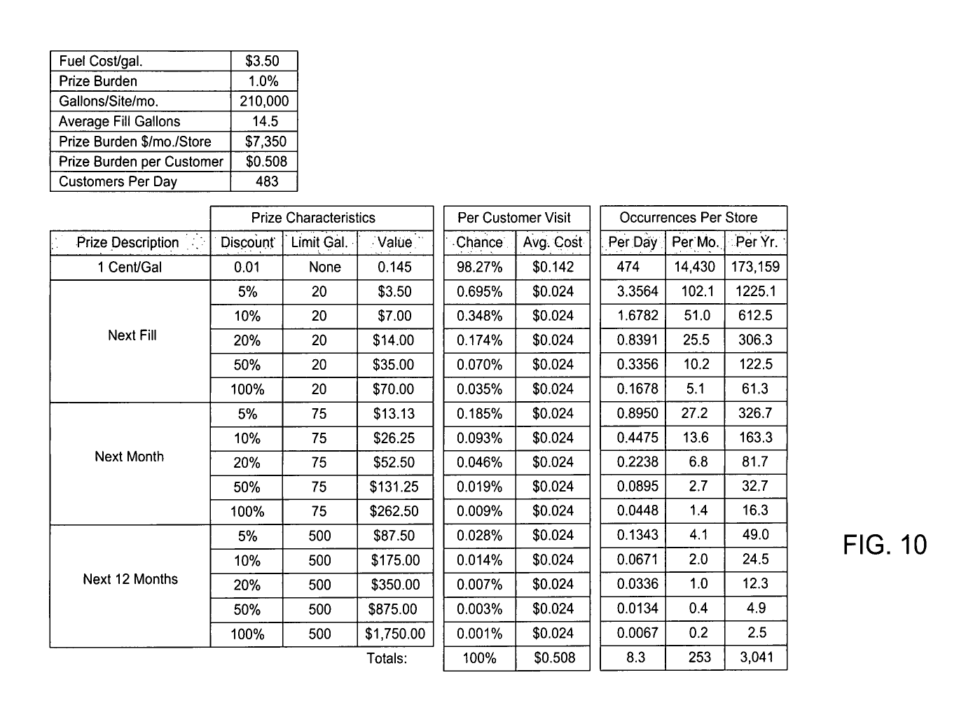

FIG. 10 is a table showing an example of discounts that could be won, a budget for them, and the probability of a customer winning them for a game of chance at the gas pump pay station of FIG. 9. In other words, FIG. 9 shows prizes and cost example for a game of chance at the gas pump (or at another location).

FIG. 11 is a perspective view of a tag 150 and tag reader 110 usable with the gas pump pay station of FIG. 9. The tag 150 may be, for example the value carrier 40 as shown and described with respect to FIG. 5, and the tag reader 110 may be the RFID transceiver 50 as shown and described with respect to FIGS. 3 and 4. The tag reader 110 is shown installed in the gas pump pay station in FIG. 9 at a location; however, any other location for the tag reader 110 on the gas pump pay station is within the scope of embodiments. The value carrier (e.g., the key tag as the value carrier) is convenient to the customer, includes a game of chance with its use, may include no moving parts (thus decreasing malfunctioning of the value carrier), and allows account info to be present on the server with a credit card link, customer history, and discounts won by the customer. Ultimately, the value carrier may increase brand recognition and market share for the merchant.

Optionally, prizes, incentives, benefits, bonuses, discounts, etc. may be awarded to the customer via a bar-coded ticket dispensed as a voucher for claiming the prizes, incentives, benefits, bonuses, discounts, etc., and the customer may then redeem the voucher for the one or more prizes, incentives benefits, bonuses, discounts, etc. won by the customer. In addition or instead of the bar-coded tickets, the customer's account information (which may be stored on a server or on the value carrier itself) may include the one or more prizes, incentives, benefits, bonuses, discounts, etc. awarded to the customer, and the value carrier may be used to redeem the one or more prizes, incentives benefits, bonuses, discounts, etc. won by the customer.

For an exemplary explanation and flow chart of the operation of the value carrier and value carrier reader, the controllers, the reading of the customer ID, etc., see in particular U.S. Patent Publication No. 2007/0026916 incorporated herein by reference. Particular portions of U.S. Patent Publication No. 2007/0026916 which describe these aspects of embodiments include FIG. 19 (see also FIGS. 11, 12, 17-18, and 20), paragraphs [0087]-[0089], [0046], [0073], [0074], and [0077], and claims 63, 64, 66, and 70.

Although the discount fee is specified as the fee which may be paid by the credit card or debit card (or other type of card) owner rather than by the merchant, it is within the scope of embodiments that any other fees which are ultimately charged to the merchant for use of credit card or debit card (or other type of card) may be paid by the card owner when transferring value from the credit card or debit card (or other type of card) and the value carrier. Furthermore, it is understood that where “credit card” is referred to herein that “debit card” or other type of payment card also applies.

Although the device 10 is disclosed herein for dispensing and adding value to the value carrier, it is within the scope of embodiments that any other type of device or method, including a cashier at the cashier's station, may also or instead dispense and/or add value to the value carrier using a carrier reader as well as optionally register the user of the value carrier to associate that user with the value carrier.

Although the incentives or prizes described herein involve gas, it is within the scope of embodiments that any other product and/or services of the merchant may be used as prizes or incentives. Additionally, any goods and/or services (including only goods and/or services selected by the merchant) may be purchased using the value carrier, including goods or services other than gasoline, to count as a customer purchase using the value carrier being eligible for one or more discounts, prizes, incentives, bonuses, etc. Furthermore, although the games of chance, incentives, and prizes disclosed herein are described as awarded at the gas pump pay station and the payment with the value carrier is described in relation to gas pump pay station, it is within the scope of embodiments that the prizes, games, and incentives may be awarded or played and the payment with the value carrier may be made at any other merchant location, including at a kiosk outside or inside the merchant's store or at a checkout station/pay station inside or outside the merchant's store, including a grocery store checkout/pay station. In some embodiments, the value carrier reader 110 may be located at a store checkout/pay station of the merchant to allow payment by the value carrier 150 upon purchase of goods and/or services of the merchant. Additionally, currency may optionally be loadable onto the value carrier 150 at the store checkout/pay station of the merchant, thus permitting the customer to pay the discount fee of his or her credit card, debit card, or other card for the opportunity to play the game of chance or be awarded a prize or incentive.

Other embodiments include a method for reducing the net cost of credit card (or debit card or other type of payment card) merchant fees, e.g., discount fees, by recovering those costs from the consumer. The method may incorporate the use of a kiosk or other value carrier or card dispensing device (e.g., similar to the device 10 described herein relation to FIG. 2) for the issuance of a value carrier, e.g., a magnetically encoded value card (“Value Card”) with either a magnetic-stripe or an RFID antenna embedded in the card (e.g., the card shown and described herein in relation to FIG. 5). The Value Card may act much in the way of a single-merchant gift card, but it also makes the owner eligible for certain bonuses and rewards, for example the bonuses and/or rewards attainable upon playing the games of chance or incentives or prizes disclosed herein.

Under this method of embodiments, the customer would insert cash, coins or a credit or debit card (or other type of card) in the kiosk for exchange into the Value Card. The face value of the Value Card would be lower than the sales price charged to the customer. For example, a $100 Value Card could be sold in exchange for a premium amount, for example, $102 of cash or credit. The premium would constitute the card loading (or reloading) fee. Although the face value would be lower than the sales price, the customer could obtain additional discounts, incentives, prizes, and bonuses for using the Value Card (e.g., via one or more of the games of chance disclosed herein), making it more valuable than the face value in purchasing power.

In this embodiment, any incentives for a customer to pay in cash may be presented in terms of a discount from the sales price, instead of charging a surcharge, swipe fee, checkout fee or other service charge for using a credit card.

Transactions with the Value Card may be characterized, for example, as credit exchange or quasi-cash transactions. Quasi-cash transactions are processed as purchases. A uniform surcharge for purchasing the Value Card applied regardless of the method of payment may optionally be charged to the customer. Beyond this, two pricing options are possible in embodiments:

Pricing Option 1. All methods of payment include a premium purchase price over the face value of the Value Card. The loading (or reloading) fee would be the same for the Value Card regardless of method of payment.

Pricing Option 2. Discounts may be given to consumers based upon their method of payment and the relative transaction cost of the method of payment. For example, a cash payment could receive a greater discount then a transaction involving a debit card or a credit card, and discounts could be tied to the rate of merchant discount charged by the acquiring bank. Real-time information may be available on a transaction by transaction basis of the reasonably estimated or actual cost of a particular method of payment at the time of purchase, so that the discount could be computed based upon the particular form of payment presented.

Embodiments may be structured with a sales price for the Value Card with a premium or surcharge over the face amount of the Value Card for a loading (or reloading) fee. Discounts may be based upon the method of payment. Pricing may be structured to ignore the benefit to the customer paying the merchant with cash or with a debit card (or other type of card) with a lower merchant discount fee. Alternatively, the pricing structure may reflect that certain methods of payment are less costly for the merchant to accept with graded discounts based upon the relative costs of each method of payment.

It is contemplated by the inventors that one or more features and/or one or more components of any and all embodiments shown or described herein may be combined with one another.

Some embodiments generally include a method for dispensing a value carrier or adding value to a value carrier, as shown and described herein. Other embodiments include a device for dispensing a value carrier or adding value to a value carrier, as shown and described herein.

Embodiments may include a method for purchasing goods or services at a purchasing location having a value carrier reader using a value carrier, as shown and described herein. In some embodiments, the purchasing location is a gasoline pump, and wherein one or more marketing tools are used at the gasoline pump as an incentive for the consumer paying for gasoline with the value carrier, as shown and described herein. In some embodiments, the one or more marketing tools comprise a game of chance or spin the nozzles, as shown and described herein.

Embodiments may include a device for purchasing goods or services at a purchasing location having a value carrier reader using a value carrier, as shown and described herein. Further embodiments may include a method for dispensing a value carrier or adding value to a value carrier, as shown and described herein.

Embodiments may include a device for dispensing a value card or adding value to a value card, as shown and described herein. In some embodiments, the face value of the value card is lower than the sales price for the value card charged to a customer.

Embodiments may include a method for purchasing goods or services at a purchasing location having a value card reader using a value card, as shown and described herein. In some embodiments, the purchasing location is a gasoline pump, wherein one or more marketing tools are used at the gasoline pump as an incentive for the consumer paying for gasoline with the value card, as shown and described herein. In other embodiments, the one or more marketing tools comprise a game of chance or spin the nozzles, as shown and described herein. In yet other embodiments, the face value of the value card is lower than the sales price charged to a customer. In yet further embodiments, the customer obtains additional discounts or bonuses for using the value card to purchase goods or services.

Additional embodiments include a device for purchasing goods or services at a purchasing location having a value card reader using a value card, as shown and described herein.

While the foregoing is directed to embodiments of the present invention, other and further embodiments of the invention may be devised without departing from the basic scope thereof, and the scope thereof is determined by the claims that follow.

1. A method for charging a discount fee of a credit card or debit card to a customer, comprising:
providing a value carrier to the customer usable at one or more purchasing locations to purchase goods or services of a merchant;
adding monetary value to the value carrier using the customer's credit card or debit card; and
charging the credit card or debit card discount fee to the customer so that the value carrier has less monetary value than was charged by the customer to the credit card or debit card.

2. The method of claim 1, wherein at least a portion of the discount fee is used to provide an incentive, benefit, prize, bonus, or discount on goods or services to the customer.

3. The method of claim 2, wherein the incentive is a game of chance with a chance for the customer to win a benefit, prize, bonus, or discount on services or goods.

4. The method of claim 1, further comprising providing an incentive, benefit, prize, or discount on goods or services to the customer when the customer uses the value carrier to purchase goods or services at the one or more merchant locations.

5. The method of claim 1, further comprising providing an incentive, benefit, prize, bonus, or discount on goods or services to the customer when the customer uses the value carrier to purchase goods at a merchant gasoline pump.

6. The method of claim 5, wherein the incentive is one or more games of chance providing the customer the chance to win a quantity of gasoline.

7. The method of claim 5, wherein the incentive provides the customer the chance to win one or more goods or services of the merchant.

8. The method of claim 1, wherein the value carrier is a radio frequency identification (RFID) transponder and wherein adding the monetary value to the RFID transponder may be accomplished using an RFID transceiver.

9. The method of claim 8, further comprising placing the RFID transponder in proximity to an RFID transceiver located at a merchant gasoline pump to pay for gasoline with the RFID transponder.

10. The method of claim 8, further comprising:
providing a kiosk for housing the RFID transceiver and a credit card or debit card reader; and
adding the monetary value to the RFID transponder from the credit card or debit card by reading the credit card or debit card using the reader and placing the RFID transponder in proximity to the RFID transceiver.

11. The method of claim 10, further comprising placing the RFID transponder in proximity to an RFID transceiver located at a merchant gasoline pump to pay for gasoline with the RFID transponder.

12. The method of claim 1, wherein the merchant purchasing location is a gasoline pay station.

13. The method of claim 1, further comprising providing an incentive, benefit, prize, or discount on goods or services to the customer when the customer uses the value carrier to purchase a threshold quantity or monetary amount of goods or services at the one or more merchant locations.

14. An apparatus for charging a discount fee of a credit card or debit card to a customer, comprising:
a credit card or debit card reader for reading information from a credit card or debit card of a customer;
a value carrier reader for reading a currency value amount on a value carrier and for adding currency value to the currency value amount;
a processor for transferring currency value from the credit card or debit card of the customer to the value carrier and for charging the discount fee to the customer; and
a display for displaying the currency value amount on the value carrier and currency value which may be added to the value carrier from the credit card or debit card.

15. A method for purchasing goods or services at one or more merchant purchasing locations having a value carrier reader using a value card, comprising:
providing a value carrier to the customer usable at one or more merchant purchasing locations to purchase goods or services of the merchant;
adding monetary value to the value carrier using the customer's credit card, debit card, or other currency, the monetary value added to the value carrier being less than the sales price charged to the customer; and
upon the customer's use of the value carrier to purchase goods or services at one or more of the merchant purchasing locations, providing one or more incentives, benefits, prizes, bonuses, or discounts on goods or services or providing or one or more chances to win incentives, benefits, prizes, bonuses, discounts on goods or services to the customer using at least a portion of the difference between the sales price and the monetary value.

16. The method of claim 15, wherein the merchant purchasing location is a gasoline pump, and wherein one or more marketing tools are used at the gasoline pump as an incentive for the consumer paying for gasoline with the value carrier.

17. The method of claim 16, wherein the one or more marketing tools comprise a game of chance providing the customer the chance to win a quantity of gasoline upon use of the value carrier.

18. The method of claim 16, wherein the one or more marketing tools provide the customer the chance to win one or more goods or services of the merchant upon use of the value carrier.

19. The method of claim 15, wherein the sales price charged to the customer is determined by method of payment and its relative transaction cost to the merchant.

20. The method of claim 19, wherein the relative transaction cost to the merchant is determined in real time based upon the particular form of payment presented by the customer.
